(19) United States
(12) Patent Application Publication
(10) Pub. No.: US 2016/0001297 A1
(43) Pub. Date: Jan. 7, 2016

(54) Method for automatic classification separately collection and automatic transportation of the solid waste

(71) Applicant: Zeguo Qiu, Shenzhen (CN)

(72) Inventor: Zeguo Qiu, Shenzhen (CN)

(21) Appl. No.: 14/325,363

(22) Filed: Jul. 7, 2014

(51) Int. Cl. B02C 18/00; B02C 25/00; B02C 23/08; B07C 5/34

(52) U.S. Cl. CPC B02C 18/0092; B07C 5/34; B02C 25/00; B02C 23/08

(57) ABSTRACT

A method for automatic classification separately collection and automatic transportation of the solid waste is designed to replace the manual door to door collection of the waste by the computer, and getting the waste for valuable recycle and reuse comprises of putting the waste into the automatic waste collectors set at the source of the waste producing and connected with pipeline, identifying the waste by the main board (21), classifying the waste by the selector (6), depositing the waste in the containers (1), (2) and (3), fluidizing the wastes by rolling fluidizing assembly (15), under the monitoring of the supervisory control center, separately transporting the wastes into the correspond waste recycle center, and getting the solid waste automation.

This application claims the benefit under 35 USC 119 to application 201310331283.3 filed in China on Jul. 27, 2013 and to application 201310547452.7 filed in China on Nov. 7, 2013.

### BACKGROUND

1. Field of the Invention

The present invention, a method for automatic classification separately collection and automatic transportation of the solid waste, pertains, in general, to the solid waste automation, which the municipal waste can be separately collected by the management of computer, to the automatically classifying, automatic separately collection and transportation of the solid waste, to all kinds of the solid wastes automatically classifying, automatically collecting, automatically discharging, automatically transporting, and getting the renewable uniform and simplified wastes for recycling and reuse.

2. Background Art

The municipal waste will be separately collected by the management of computer in the head office. An method for automatic classification separately collection and automatic transportation of the solid waste is designed to reach all kinds of the solid waste automatically classifying, separately collecting, automatically discharging and transporting, and getting uniform and simplified waste without plastic package for recycling and reuse.

Solid waste is a huge challenge for the dwellers, municipalities, industries, and businesses. It is expensive and time consuming to collect millions of tonnes of trash every year, and there are risks to the environment.

Solid waste itself is good resource for recycle and reuse. In the modern time, the increasing consumption of commodity causes large contaminated plastic involved in the waste that devalues the waste.

Current process for the solid wastes in the world are that putting the solid wastes into specified containers, packaging by the plastic package, door to door collecting, and transporting to the specified disposal site. It is time consuming, energy wasting, resource destroying, inconvenience and high cost. Besides, it caused the wastes and the plastic package cross-contamination that devalues the wastes. Disposal such wastes are landfill and incinerating. However, landfill and incinerating are pollutant transfer, which cause serious secondary pollution. In the modern city, the population increasing and economic development lead to the municipal waste increasing dramatically. The urban expending causes the shortage of the landfill site. The incinerating causes serious air pollution that threatens the health of the population and exacerbates the pollution of PM 2.5. The municipalities face the big challenge of the solid waste. The City's waste prevention and recycling programs have evolved dramatically from their inception in the 1980s. Recycling has its origins in fledgling voluntary programs. It depends the manual identification and voluntary classification which are impacted by human's consciousness, behaviors and knowledge. The efficiency is less. Over the years, the municipalities and governments cost high to have established an array of programs to promote reduction, reuse and recycling of wastes generated by residents, businesses, government agencies, schools and institutions. No matter how strive they did, the solid waste impact is increased and the reduce, reuse and recycle rate are declined. Identifying and classifying the wastes by manual can cause faults easily, besides the waste collection and transportation depend the plastic package that cause much plastic and waste cross-contamination, increase the cost and difficulty for recycle and reuse. The finally disposal for such waste is landfill and incinerating.

How to make the waste go automatically without plastic package? Currently, there is less research, patent and essay involved in the waste automation. The patents about food and closet waste disposers, which set under dishpan, galley sink as well as the spittoons, are limited on shredding food scraps and closet wastes to prevent the drainage jam. It makes all of the waste scraps flush into public drainage system that causes the increase of waste water, consuming large of fresh water. It transfers solid waste into wastewater that exacerbates the waste pollution, causes the difficult for purifying and largely increases the cost.

The waste stationary vacuum collecting system set for solid waste transportation which used big pipeline with the diameter larger than 75 cm. It cannot be widely practiced, because it is difficult to reach at the source of the waste, such as kitchen. Therefore, the waste all the same needs the plastic package, transports to a specified site. Disposal such waste collected is the same as landfill and incineration. Besides it is easy caused the pipeline jam. The cost for the pipeline construction, operation and maintenance are extremely high.

The previous application, CN200910106173.0 and U.S. Ser. No. 12/504,657, transfer the solid waste into liquid that makes the waste conductible and largely reduce the cost of pipeline construction, operation and maintenance. However, the classification of the waste has to depend the voluntary identification by human and the fluidizing assembly has to equip with high speed motor that could cause the noise and reduce the efficient.

The identifying ability of human and citizen is limited. There are many kinds of waste, taking the plastic for example, plastic contains many different kinds, such as PP, PCV, PE, and PET. The appearance looks the same. It is difficult for the human and citizens to identify.

The invention hereby is to build an effective, quiet and safer apparatus to deal with such problem, modifies the previous application, to overcome the mistake and identifying ability of human, and achieve all kinds of the solid wastes automatically classifying clearly, automatically collecting, separately discharging and transporting, and getting at all of the wastes renewable without the plastic package, to reach at the aim which the door to door collection for the waste replaced by clicking a mouse in the office.

### SUMMARY

The present invention, a method for automatic classification separately collection and automatic transportation of the solid waste, contemplates a feasible process and apparatus to automatic classify the waste clearly, overcome the faults, mistake and identify ability of human and citizen, replacing the door to door collection of the waste by computer, quiet and efficiently fluidizing the waste into conductible and flowable particle, achieve solid waste automatic classification, automatic collection and get the plastic package free uniform waste for recycle and reuse. The invention designed a process of:

Inputting the distinct data of each waste such as waste A, waste B and waste C, into the main board (21), the data including the distinct of the form, moving, color, mark and character, odor, sounder, sonic inspection, optical inspection, electrics and magnetics, structure, thermoelectric, elasticity and density of each waste;
Setting the automatic waste collectors in the source of waste production, such as kitchen, and connecting the automatic waste collectors and recycle centers with pipeline;
Putting the waste into the waste receptor (8) by the monitoring of optical detector (7) and camera (11);
Dropping waste into the waste selector and producing sounder by the collision;
Detecting the waste's distinct of the form, moving, color, mark and character, odor, sounder, sonic inspection, optical inspection, electrics and magnetics, thermoelectric, elastic, structure and density by the combined detector and sensor assembly (9), optical detector (7) and camera (11);
Comparing the instinct data of each waste inputted in the main board;
Identifying the waste by the main board (21) according the distinct detected by combined detector and sensor assembly (9), optical detector (7) and camera (11);
Putting the identified waste A into container (1), waste B into container (2), and waste C into container (3) by the waste selector (6) instructed by the main board (21);
Depositing the wastes in the containers separately;
Turning on the power of the automatic waste collector by the instruction of the supervisory control center (34) through remote information exchange system and pressure sensor (22);
Driving by the motor (32);
Fluidizing the waste B into flowable particle by the rolling fluidizing assembly (15) and exporting into the pipeline by the outlet valve and pumper assembly (23);
Turning the automatic dispatch valve (20) toward to waste B recycle center (18) by the instruction of supervisory control center (34);
Transporting the fluidized waste B into waste B recycle center (18) by the regional pumper;
Cleaning the container and pipeline by the spray (12) automatically;
Moving container (1) toward to the center position and pushing waste A into the rolling fluidizing assembly (15) by the driving and rail assembly (5);
Fluidizing the waste A into flowable particle by the rolling fluidizing assembly (15);
Turning the automatic dispatch valve (20) toward to waste A recycle center (17) by the order of the supervisory control center (34);
Transporting the fluidized waste A into waste A recycle center (17) by the pumper;
Returning the container (1) back to the original position;
Dropping waste C into rolling fluidizing assembly (15) by moving container (3) toward to center by the driving and rail assembly (5);
Fluidizing the waste C into liquid by the rolling fluidizing assembly (15);
Turning the automatic dispatch valve (20) toward to waste C recycle center (19) by the order of the supervisory control center (34);
Getting the simplified waste A, waste B, waste C without plastic package for recycle;
Preventing the hazard being put in by the alarm assembly set in the automatic waste collector, when the hazard, the battery, chemical spray and paint being put in the selector, the alarm and voice warning assembly turning on by the main board (21) according to the detected information from the odor, electric and magnetic detector assembly (9) and camera (11);
Sending the date recorded in the main board (21) to the supervisory control center (34) by the remote information exchange system; That reaches at the aim of automatic classification, separately collection and automatic transportation of the solid waste and getting the simplified waste without of the plastic package for valuable recycle, and getting at the aim of replacing the manual door to door collection of the waste by computer in the office.

### BRIEF DESCRIPTION OF DRAWINGS

FIG. 1 is the section view of the method and it's apparatus.

FIG. 2 is the section view of the rolling fluidizing assembly.

FIG. 3 is the section view of the saw and cut roller couple.

FIG. 4 is the section view of the simplified rolling waste fluidizing assembly.

FIG. 5 is the section view of the extended automatic waste collector.

FIG. 6 is the section view of the waste automatic collection project for residents.

### DETAIL DESCRIPTION

With reference to accompanying drawings, the present invention, the method automatic classification is explained in details. the component of the waste is very complex, however each waste has it's distinct of appearance, color, form, physical, chemical. Besides, there are many marks and characters on the waste from the consumed commodity, such as bar code, dimensional code. To reach at simplifying and high efficient, the invention designed the identifying and classifying method of:

1. Reading identification, defining the color, mark, character, code, bar code and dimensional code of each waste, and getting the data from commodity, inputting the data of the color, mark, character, code, bar code and two dimensional code of each waste into the main board, putting the waste into the receptor (8), scanning and reading the color, mark, character, code, bar code and two dimensional code on the waste by the optical detector (7) and camera (11), identifying the waste by the main board (21), putting the identified waste into specified container, getting the classified waste.
2. Sounder identification, putting each waste into the receptor (8), following down to the selector (6) and cause sounder by collision, record the sounder of each waste as data, inputting the sound data into the main board (21); putting each waste into the receptor (8), following down to the selector (6), the sound detected by the sound and sonic detector (9), identifying by the main board (21), getting the classified waste.
3. Optical identification, inputting the absorptance and reflectance of each waste into the main board (21), putting the waste into the receptor (8), following down to the selector (6), identifying the waste by the main board according to the absorptance and reflectance of the waste detected by the optical detector (7), putting the waste into specified container, and getting the classified waste.
4. Electric and magnetic identification, inputting the distinct of electric and magnetic of each waste into the main board (21), putting the waste into the receptor (8), following down to the selector (6), identifying the waste by the main board according to the distinct of electric and magnetic of the waste detected by the electric and magnetic detector (9), putting the waste into specified container, and getting the classified waste.
5. Odor identification, inputting the distinct of odor of each waste into the main board (21), putting the waste into the receptor (8), following down to the selector (6), identifying the waste by the main board according to the distinct of odor of the waste detected by the odor detector (9), putting the waste into specified container, and getting the classified waste.
6. Image and graphic identification, tow dimension and three dimension identify. inputting the distinct of the image of each waste into the main board (21), putting the waste into the receptor (8), following down to the selector (6), identifying the waste by the main board according to the distinct of the image of the waste detected by the optical detector (7) and camera (11), putting the waste into specified container, and getting the classified waste.
7. Density identification and selection, inputting the distinct of the density of each waste into the main board (21), including the extended difference of the definite density set for the wastes by the manufacture, putting the waste into the receptor (8), following down to the selector (6), identifying the waste by the main board according to the distinct of the density of the waste detected by the piezoelectric detector (33) and optical detector (7), putting the waste into specified container, and getting the classified waste, and selecting the wastes collected separated into much more detail classification by the gravity selection.
8. Sonic identification, inputting the distinct of the structure of each waste into the main board (21), putting the waste into the receptor (8), following down to the selector (6), identifying the waste by the main board according to the distinct of the structure of the waste detected by the sonic detector (9), putting the waste into specified container, and getting the classified waste.
9. thermoelectric identification, inputting the distinct of the temperature of each waste into the main board (21), putting the waste into the receptor (8), following down to the selector (6), identifying the waste by the main board according to the distinct of the temperature of the waste detected by the thermoelectric detector and infrared sensor (9), putting the waste into specified container, and getting the classified waste.
10. Selective identification, inputting the distinct data of plastic only into the main board (21), putting the waste into the receptor (8), following down to the selector (6), identifying the waste by the main board according to the distinct detected, if the distinct detected by the detector assembly is plastic, putting the plastic into plastic container, if no any distinct detected, putting all of another waste into biodegradable container, and getting the classified waste.
11. Cross employed, Reading, Sounder, Optical, Electric and magnetic, Odor, Image, Density, Sonic, thermoelectric, Selective identification can be cross-employed for the waste identification.

The automatic waste collector, which is designed to a quiet, safe, high efficient and remote manageable for automatic classification, separately collection, fluidizing and automatic transportation of the waste, is comprised of: the user going near the automatic waste collector, the lid (10) is automatically opened by infrared sensor assembly, putting the waste into the waste receptor (8), and following down to the waste selector (6), the optical detector (7) and the camera (11) detect the form, moving, color, mark and character, ray absorptance and reflectance of waste, the piezoelectric sensor (33) gets the weight and density of the waste, the sonic, sounder, electronic and magnetic, thermoelectric and odor detector assembly (9) detects the temperature, collision sounder, structure, electric and magnetic, odor and elasticity of the waste, identifying the waste by the main board (21) according to the data detected, putting the identified waste A in the selector (6) into the waste container (1) by the selector driving assembly (13) and rail (14), the identified waste B into the container (2), the identified waste C into the container (3); depositing the wastes in the containers; container (2) is mounted on the top of rolling fluidizing assembling (15), instructing by the supervisory control center (34), turning on the regional vacuum pump and turning the dispatcher valve (20) set in front of the waste recycle centers toward to waste B recycle center (18), building up the pressure in the pipeline, the pressure sensor (22) set in the pipeline detects the difference of the pressure in the pipeline, and turns on the power of the automatic waste collector, driving by the motor (32), the different gear couple assembly (16) make the saw and cut roller (29) and the saw and cut roller (30) counter-rolling with different speed that forms the vertical saw and cut, and transverse cut and shred, which cut and saw the waste into particles without of noise, preventing the waste conglutination on the saw and cut rollers and directing the waste into the conducting tunnel by the comb (31), the sharp edge of the rolling screw push rod (28) and the fixed transverse cut (27) forms cutting, the circumferential face of the rolling screw push rod (28) and the grooves (26) inside the tunnel goes further cut and grind the waste and push the waste going toward to the granularity controlling screen net (24) and cut (25), by setting the diameter of the hole on the granularity controlling screen net (24), cutting by the cut (25) and the granularity controlling net (24), getting the designed granularity of the fluidized waste particles, driving by the exporting pumper (23) and the fluidized waste going through the automatic outlet valve (23) into the pipeline, and conducting waste B through the pipeline into the waste B recycle center (18) by the automatic dispatch valve (20); automatically cleaning the container and pipeline by the spray (12); modifying the working condition by a heater set in the conducting tunnel; the bottoms of container (1) and container (3) are sliding when container (1) and container (3) are moved toward the center by the container driving assembly (5) and pushing the identified wastes in the containers into the rolling fluidizing assembly (15); moving container (1) toward to center by the set program in the main board, pushing the waste A into the rolling fluidizing assembly (15), fluidizing waste A into fluidized waste particle, turning the automatic dispatch valve (20) toward to waste A recycle center (17), driving the fluidized waste A to waste A recycle center (17) by the pumper; then moving the container (3) toward to center, push the waste C into the rolling fluidizing assembly (15), fluidizing waste C into fluidized waste particle, turning the automatic dispatch valve (20) toward to waste C recycle center (19), driving the fluidized waste C to waste C recycle center (19) by the pumper; that getting the classified uniform waste A, waste B and Waste C without plastic package for valuable recycle; the controlling panel (4) set for managing the automatic waste collector; as a remote terminal unit, the automatic waste collector automatically sends the statistic date recorded in the main board (21), including the monthly producing amount of each waste, producing time period and troubleshooting report to the supervisory control center (34) by the instruction of the supervisory control center (34) through the remote information exchange system. The number of the containers set in the automatic waste collector can be extended.

Aim to reach at a quiet and high efficient, the invention designed the rolling fluidizing assembly, which of composed of driving by the different gear couple (204) and (205) with low counter-rolling speed, The sawtooth and cut on the saw and cut roller (201) and (202) forms a strong static cutting in the waste into particle without noise; the small gear (204) and large gear (205) make the saw and cut roller (201) and the saw and cut roller (202) counter-rolling with different speed that forms the vertical saw and cut, and transverse cut and shred, which cut and saw the waste into particles; preventing the waste conglutination on the saw and cut rollers and directing the waste into the conducting tunnel by the comb (203), the sharp edge of the rolling screw push rod (211) and the fixed transverse cut (213) forms the second transverse cutting, the circumferential face (212) of the rolling screw push rod and the grooves (214) inside the conducting tunnel goes further cut and grind the waste and the face (215) of the rolling screw push rod pushes the waste going toward to the granularity controlling net (206) and cut (207), by setting the diameter of the hole on the granularity controlling net (206), cutting by the cut (207) and the granularity controlling net (206), getting the designed granularity of the fluidized waste particles; the heater (210) set in the conducting tunnel is the first to modifying the working condition to accommodate the bad working condition, such as winter; the second is to soft the waste, such as to make plastic soft, shrink and directly cut into grain, to get renewed products, increase the efficient and optimize the waste recycle process; the third is to melt some waste, such as oil, and prevent it's conglutination on the parts. The rolling waste fluidizing assembly can be simplified for specified use.

Preventing the hazard being put in by the alarm assembly set in the automatic waste collector, when the hazard, the battery, chemical spray and paint being put in the selector, the alarm and voice warning assembly turning on by main board according to the detected information from the odor, electric and magnetic detector assembly (9) and camera (11), the selector (6) stops working and the lid (10) opens till the hazard, the battery, chemical spray and paint having been picked up.

The supervisory control center (34) is employed to automatically manage and monitor the automatic waste transporting pipeline, the automatic dispatch valves and the automatic waste collectors set in a regional area, the whole city and town which is comprised of center computer and controlling system, inputting the program and instruction into the computer by the human machine interface; the manager controls the system which is made of the pipeline, remote terminal unit, the automatic waste collectors, the regional pumpers and the regional dispatch valves; the data acquisition system is set for the data collection, record and display; organizing, editing and compiling the instruction and the data collected by the programmable logic controller, the information exchanges in the system by the remote information exchange system; it designed to the automatic billing, automatic statistic of the data, category, decision making, diagnosis, determining defect, troubleshooting, displaying the information in a logical and organized fashion, monitoring the wastes separately collection and transportation, pipeline working condition, making waste collection and dispatch schedule and plan.

### THE ADVANTAGE

Comparing the voluntary waste classification by citizens, Identifying and classifying the waste by the smart detector and sensor assembly and mechanic device is much accurate with very high efficient. It overcomes the limited indentifying ability of human and the faults caused by the human. It largely extends the identifying range of the waste, and makes the classification of the wastes much more detail that largely increases the value of the waste recycle. It saves the time, manpower, and reduces the liability of the citizen and user. It offers much more convenience to the citizen and user.

Comparing the fluidizing assembly, the invention, rolling fluidizing assembly (15) has the advantages of quiet, high efficient and power saving. It is equipped low rolling speed, and forms strong static, the designed sawtoothes and sharp cuts on the circumference of the saw and cut roller (201) substantively increases the efficient of the waste fluidizing. Because there is no noise, it will be widely used for the household waste collecting.

The invention, automatic pipeline transportation of the waste has the advantage of low cost, high efficient, low space occupying, and easy management. It substantively reduces the cost of the waste collection, power consumption, time consuming.

### ILLUSTRATE BY FIGURES AND EXAMPLE

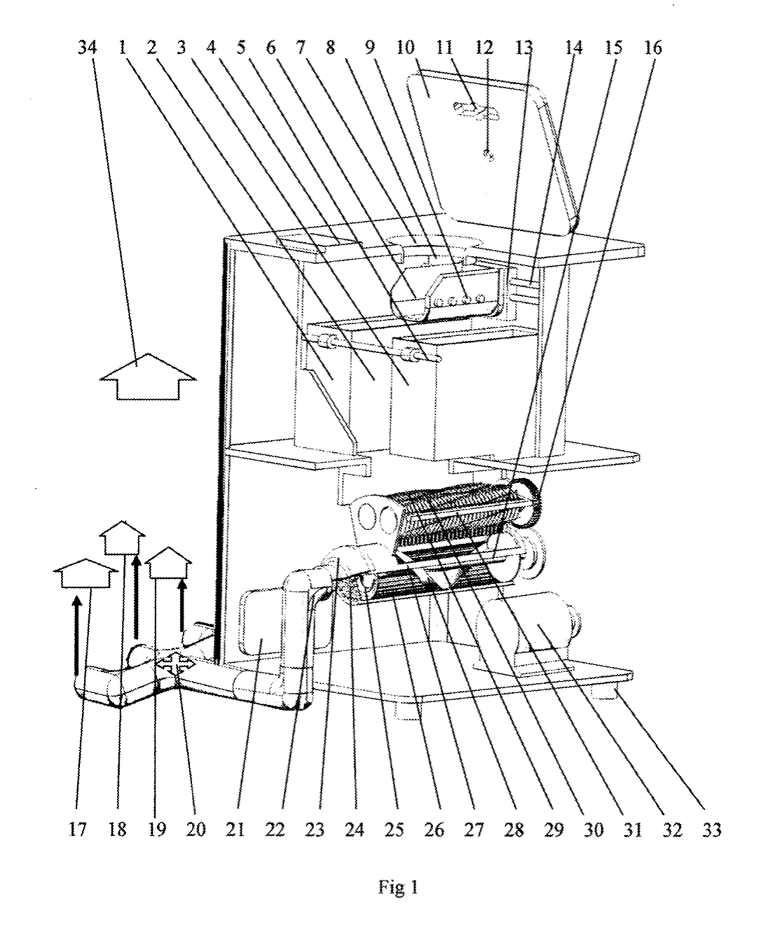

FIG. 1 is the section view of the method and it's apparatus. In it, the applicant in front is the automatic waste collector; the user going near the automatic waste collector, the lid (10) is automatically opened by infrared sensor assembly, putting the waste into the waste receptor (8), and following down to the waste selector (6), the optical detector (7) and the camera (11) get the form, moving, color, mark and character, ray absorptance and reflectance of waste, the piezoelectric sensor (33) gets the weight and density of the waste, the sonic, sounder, electronic and magnetic, thermoelectric and odor detector assembly (9) gets the temperature, collision sounder, structure, electric and magnetic, odor and elasticity of the waste, identifying the waste by the main board (21), putting the identified waste A in the selector (6) into the waste container (1) by the selector driving assembly (13) and rail (14), the identified waste B into the container (2), the identified waste C into the container (3), depositing the wastes in the containers; container (2) is mounted on the top of rolling fluidizing assembling (15), instructing by the supervisory control center (34), turning on the vacuume pump and turning the dispatcher valve toward to waste B recycle center (18), setting a pressure in the pipeline, the pressure sensor (22) set in the pipeline gets the difference of the pressure in the pipeline, and turns on the power of the automatic waste collector, driving by the motor (32), the different gear assembly (16) make the saw and cut roller (29) and the saw and cut roller (30) counter-rolling with different speed that forms the vertical saw and cut, and transverse cut and shred, which cut and saw the waste into particles, preventing the waste conglutination on the saw and cut rollers and directing the waste into the conducting tunnel by the comb (31), the sharp edge of the rolling screw push rod (28) and the fixed transverse cut (27) forms cut, the circumferential face of the rolling screw push rod (28) and the grooves (26) inside the tunnel goes further cut and grind the waste and push the waste going toward to the granularity controlling screen net (24) and cut (25), by setting the diameter of the hole on the granularity controlling screen net (24), cutting by the cut (25) and the granularity controlling screen net (24), getting the designed granularity of the fluidized waste particles, driving by the exporting pump (23) and the fluidized waste going through the automatic outlet valve (23) into the pipeline, and conducting waste B through the pipeline into the waste B recycle center (18) by the regional automatic dispatch valve (20); automatically cleaning the container and pipeline by the spray (12); modifying the working condition by a heater set in the conducting tunnel; the bottoms of container (1) and container (3) are sliding when container (1) and container (3) are moved toward the center by the container driving assembly (5), and push the identified wastes in the containers into the rolling fluidizing assembly (15); moving container (1) toward to center, push the waste A into the rolling fluidizing assembly (15), fluidizing waste A into fluidized waste particle, turning the regional automatic dispatch valve (20) toward to waste A recycle center (17), driving the fluidized waste A to waste A recycle center (17) by the regional pumper, moving container (3) toward to center, push the waste C into the rolling fluidizing assembly (15), fluidizing waste C into fluidized waste particle, turning the automatic dispatch valve (20) toward to waste C recycle center (19), driving the fluidized waste C to waste C recycle center (19) by the regional pumper; that getting the classified uniform waste A, waste B and Waste C without plastic package for valuable recycle; the controlling panel (4) set for managing the automatic waste collector; the statistic date recorded in the main board (21), including the monthly producing amount of each waste, producing time, working and troubleshooting reports are sent to the supervisory control center (34) by the instruction of the supervisory control center (34) through the remote information exchange system.

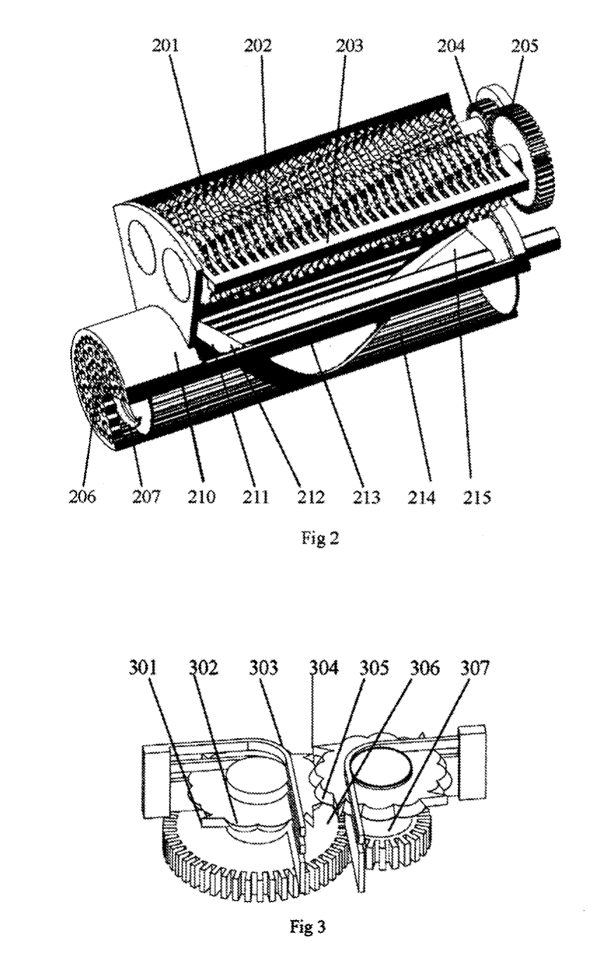

FIG. 2 is the section view of the rolling fluidizing assembly. Aim to reach at a quiet and high efficient fluidizing assembly; the invention designed the rolling fluidizing assembly. Driving by the different couple gear pair with low counter-rolling speed, the sawtooth and cut on the surface of the saw and cut roller forms a strong static, cut in the waste into particle without noise. In FIG. 2 the small gear (204) and large gear (205) make the saw and cut roller (201) and the saw and cut roller (202) counter-rolling with different speed that forms the vertical saw and cut, and transverse cut and shred, which cut and saw the waste into particles, preventing the waste conglutination on the saw and cut rollers and directing the waste into the conducting tunnel by the comb (203), the sharp edge of the rolling screw push rod (211) and the fixed transverse cut (213) forms the second transverse cutting, the circumferential face (212) of the rolling screw push rod and the grooves (214) inside the conducting tunnel goes further cut and grind the waste, and the face (215) of the rolling screw push rod pushes the waste going toward to the granularity controlling screen net (206) and cut (207), by setting the diameter of the hole on the granularity controlling screen net (206), cutting by the cut (207) and the granularity controlling screen net (206), getting the designed granularity of the fluidized waste particles; the heater (210) set in the conducting tunnel is the first to modifying the working condition to accommodate the winter; the second is to soft the waste, such as to make plastic soft, shrink and directly cut into grain, that gets renewed products, increase the efficient and optimize the waste recycle process; the third is to melt some waste, such as oil, and prevent it's conglutination.

FIG. 3 is the section view of the saw and cut roller couple. In it, the saw and cut roller are formed by the sawtooth (301) and cut (302), the comb (303) in between, when the large gear (306) and small gear (307) counter-rolling drives the saw and cut rollers rolling with difference speed, that forms the vertical saw and cut (305), and transverse cut, saw and shred (304), which cut, saw and shred the waste into particle and drive the waste particle following the comb (303) down to conducting tunnel and preventing the waste conglutination on the saw and cut rollers.

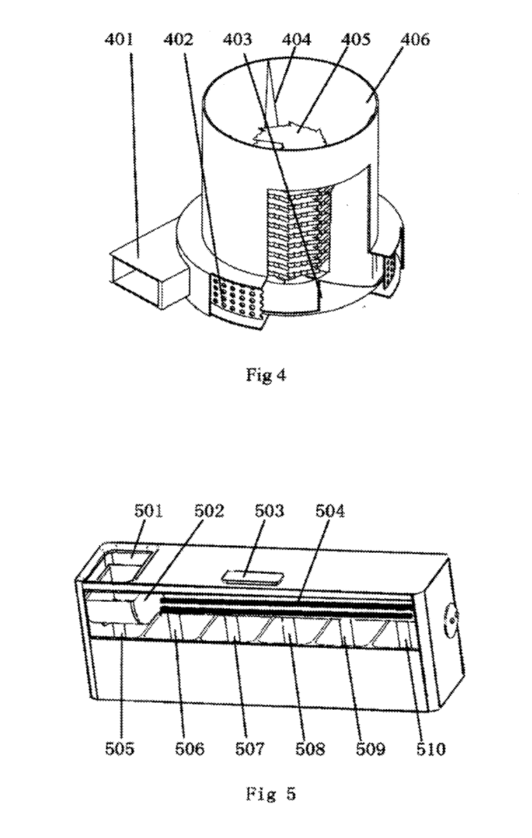

FIG. 4 is the section view of the simplified rolling waste fluidizing assembly. In it, the rolling screw push rod and the saw and cut roller couple are combined in one. The indentified waste following down to the waste container (406) and deposit in it; driving by the motor, the buffer (404) pushes the waste toward to the rolling screw push rod (405), which the circumferential face is made of sawtooth and cut, the push rod (405) saws and cuts the waste into particle and pushes the waste particle down to the granularity controlling screen net (402) and bevel edge cut (403), which set to reduce the resistance and promote the efficiency, the granularity controlling screen net (402) and bevel edge cut (403) forms the second cutting and cuts the waste into designed granularity particle by the controlling of the granularity controlling screen net (402), driving by the centrifugation formed by the bevel edge cut (403), the fluidized waste going through the out let (401) into the connected pipeline.

FIG. 5 is the section view of the extended automatic waste collector. Inputting the data about the form, moving, color, meaningful mark and character, odor, sounder, sonic inspection, optical inspection, electrics and magnetic, structure, thermoelectric, elasticity and density of waste A, waste B, waste C, waste D, waste E, and waste F into the main board (503); putting the waste into the waste receptor and detector assembly (501), and following down to the waste selector (502); identifying the waste by the main board (503) according the waste data detected, putting waste A into container (505), waste B into container (506), waste C into container (507), waste D into container (508), waste E into container (509), and waste F into container (510), automatic classifying the waste in much more details.

Example 1, the industrial application. In general, most house hold waste contains plastic, paper, metal and biodegradable waste. There are different instincts of reflectance, absorptance, color, mark and character, electric and magnetic between plastic, paper and metal. Inputting the data of plastic and paper waste's instinct of the reflectance, absorptance, color, mark and character into the main board (21) and inputting the metal waste's instinct of electric and magnetic into the main board in the same time; Setting the automatic waste collectors in the source of residence, industrials and commercial units, such as kitchen and public square; going near the automatic waste collector, automatically opening the lid (10) by the infrared sensor assembly; putting the waste into the waste receptor (8), and following down to the waste selector (6), detecting the instinct of the form, color, mark and character, ray absorptance and reflectance of waste by the optical detector (7); detecting the instinct of electronic and magnetic of the waste by the detector assembly (9); identifying the waste by the main board (21), putting the identified plastic waste and metal waste in the selector (6) into the waste container (1) by the selector driving assembly (13) and rail (14); when the lid opening, putting the waste into the selector, if no any instinct relevant plastic, metal and paper identified, taking is as the biodegradable waste involve and putting the waste into the container (2); the identified paper waste into the container (3), depositing the wastes in the containers; container (2) is mounted on the top of rolling fluidizing assembling (15), instructing by the supervisory control center (34), turning on the vacuume pump and turning the dispatcher valve toward to biodegradable waste recycle center (18), setting a minus pressure in the pipeline, the pressure sensor (22) set in the pipeline gets the difference of the pressure in the pipeline, and turns on the power of the automatic waste collector, driving by the motor (32), the different gear assembly (16) make the saw and cut roller (29) and the saw and cut roller (30) counter-rolling with different speed that forms the vertical saw (305) and cut, and transverse cut and shred (304), which cut and saw the waste into particles, preventing the waste conglutination on the saw and cut rollers and directing the waste into the conducting tunnel by the comb (31), the sharp edge of the rolling screw push rod (28) and the fixed transverse cut (27) forms cut, the circumferential face of the rolling screw push rod (28) and the grooves (26) inside the tunnel goes further cut and grind the waste and push the waste going toward to the granularity controlling screen net (24) and cut (25), by setting the diameter of the hole on the granularity controlling screen net (24), cutting by the cut (25) and the granularity controlling screen net (24), getting the designed granularity of the fluidized waste particles, driving by the exporting pump (23) and the fluidized waste going through the automatic outlet valve (23) into the pipeline, and conducting biodegradable waste going through the pipeline into the biodegradable waste recycle center (18) by the regional automatic dispatch valve (20); automatically cleaning the container and pipeline by the spray (12); modifying the working condition by a heater (210) set in the conducting tunnel; the bottoms of container (1) and container (3) are sliding when container (1) and container (3) are moved toward the center by the container driving assembly (5), and push the identified wastes in the containers into the rolling fluidizing assembly (15); moving container (1) toward to center, push the plastic and metal waste into the rolling fluidizing assembly (15), fluidizing plastic and metal waste into fluidized waste particle, turning the regional automatic dispatch valve (20) toward to the plastic and metal waste recycle center (17), driving the fluidized plastic and metal waste to the plastic and metal waste recycle center (17) by the regional pumper; moving container (3) toward to center, push the paper waste into the rolling fluidizing assembly (15), fluidizing paper waste into fluidized waste particle, turning the automatic dispatch valve (20) toward to the paper waste recycle center (19), driving the fluidized paper waste to paper waste recycle center (19) by the regional pumper; that getting the classified uniform plastic and metal waste, biodegradable waste and paper waste without plastic package for valuable recycle; the controlling panel (4) set for managing the automatic waste collector; the statistic date recorded in the main board (21), including the monthly producing amount of each waste, the plastic waste, the biodegradable waste and the paper waste, producing time, working and troubleshooting reports are sent to the supervisory control center (34) by the instruction of the supervisory control center (34) through the remote information exchange system. There is difference amount of waste in different collectors in a regional that the fluidizing time is different. By the monitoring system through the remote information exchange assembly, arraying the waste information and working condition of each collector on the display in the supervisory control center reach at completely clean each automatic waste collector in the regional. Separating the plastic and metal waste collected by the gravity and getting the separated waste collected.

Example 2, the plastic indentifying in details. There are difference of ray absorptance and reflectance among PE, PP, PVC, PET, PS, composited plastic products and aluminum. Putting the instinct of the absorptance and reflectance of PE, PP, PVC, PET, PS, composited plastic product and aluminum into main board (503); putting the waste into the waste receptor and optical detector assembly (501), and following down to the waste selector (502); identifying the waste by the main board (503) according the waste data detected, putting PE waste into container (505), PP waste into container (506), PVC waste into container (507), PET waste into container (508), PS waste into container (509), and the composited plastic products and aluminum waste into container (510), that getting the classified waste in much more details.

Example 3, Density identification and selection. There is difference of density in each waste. However, the density of some wastes is very close. To extend the difference, the manufacture can set a definite density for the product before it's being waste. Taking the plastic for example, by mixing the air bubble, heavy power and metal into the PE, PP and PVC, extend the difference of the density, setting 0.50 for PE, 1.00 for PP, 1.5 for PVC. Inputting the distinct of the density of each waste into the main board (21), including the difference of the definite density set for the waste by the manufacture, putting the waste into the receptor (8), following down to the selector (6), identifying the waste by the main board according to the distinct of the density of the waste detected by the piezoelectric detector (33) and optical detector (7), putting the waste into specified container, and getting the classified waste, and furthermore making the waste collected separated into much more detail classification by the gravity selection. Putting the waste of PE, PP, and PVC into water, by the gravity, PE flows up to the top layer, PP in between, and PVC deposits on the bottom that gets the clearly classified PE, PP and PVC for recycle and reuse:

Example 4, reading identification and separately collection. There are many kinds of waste, taking the plastic for example, plastic contains many kinds, such as PP, PCV, PE, and PET. The appearance looks the same. It is difficult for the citizens to identify. Most of the package from commodity is marked by labels, reading the label can get the data of the component of waste. Defining the color, marking and character on the waste and putting color on the waste can easy the waste identification. If the manufacture marks the color on products before it's being the waste, such as black for PE, red for PP and white for PVC, that can be directly detected by optical detector (7) and camera (11), and simplifying the identifying process. Coding the plastic wastes, such as PE, PP, PVC, PS, PT, and composited plastic products, the paper waste, the metal and the glass with marks, characters and colors; Inputting the definite code data of each waste into the main board of the automatic waste collector; putting the wastes into the waste receptor and falling down to the waste selector; reading the code on the wastes by the optical detector and camera assembly (501); identifying the waste by the main board (503); separately putting PE waste, PP waste, PVC waste, PS waste, PT waste, and composited plastic products waste, paper waste, metal waste and glass waste into the specified containers, PE waste container, PP waste container, PVC waste container, PS waste container, PT waste container, and composited plastic products waste container, paper waste container, metal waste container and glass waste container; depositing the wastes separately in the containers; separately fluidizing the wastes in the containers; alternatively turning the dispatch valve toward PE waste recycle center, PP waste recycle center, PVC waste recycle center, PS waste recycle center, PT waste recycle center, and composited plastic products waste recycle center, paper waste recycle center, metal waste recycle center and glass waste recycle center; driving by the pumper, transporting the fluidized wastes into the correspond recycle center; getting the classified uniform wastes without the plastic package for valuable recycle.

Example 5, sounder identification. Recording the collision sounder caused by each waste falling down to the selector, such as metal, glass, plastic, biodegradable waste and paper; inputting the sounder record into the main board; separately putting the metal, glass, plastic, biodegradable waste and paper wastes into the selector; detecting the sounder caused by the collision; identifying the wastes by comparing the collision sounder inputted in the main board; separately putting the identified metal, glass, plastic, biodegradable waste and paper wastes into the correspond metal container, glass container, plastic container, biodegradable waste container and paper container; getting the classified wastes.

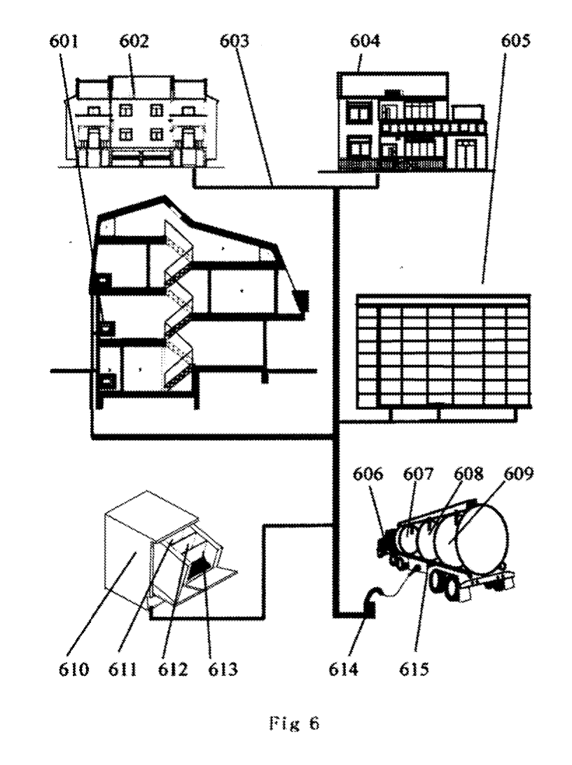

Example 6, the automatic waste collection project for residence. FIG. 6 is the section view of the automatic waste collection project for residence. Setting the automatic waste collectors (601) in the source of waste production, such as the kitchen, including the cabinet (610) in the kitchen of the residence, the houses (602), (604) and condos (605); connecting the automatic waste collectors (601) with pipeline (603); setting the regional outlet (614) beside the road; putting plastic waste into container (611), biodegradable waste into container (612), and paper waste into container (613); depositing the wastes in the containers; connecting the outlet with the pipe set on the mobile collecting truck which is coming according a set time schedule; starting up the automatic waste collectors (601) in the residence by the instruction of the mobile supervisory controlling center (606) set in the truck; separately fluidizing the wastes deposited in the containers; alternatively transporting the fluidized plastic waste into the mobile container (607), the fluidized biodegradable waste into the mobile container (608), and the fluidized paper waste into the mobile container (609) through the automatic dispatch valve (615); getting the classified uniform fluidized wastes without plastic waste for recycle; Transporting the wastes to the recycle center by the collecting truck.

Example 7, hazard preventing. When the hazard waste has been put into the automatic waste collector, such as battery, chemical spray and paint, detecting by the odor and metal detector assembly (9), and optical detector (7), the main board (21) starts up the alarming assembly, the lid opening, the voice guides the user pick it up, the automatic waste collector stops working till the hazard being picked up.

Example 8, the application for medical waste. Setting the automatic waste collector at the source of the medical waste production; Connecting the automatic waste collectors and the carbonization tank with the pipeline; automatically opening the lid of the automatic waste collector by the infrared sensor assembly, when the user coming near the automatic waste collector; Directly putting the medical waste into the waste container set in the automatic waste collectors, and depositing the medical waste in the container; automatically disinfecting the lid and the receptor by the automatic disinfecting assembly; automatically starting the automatic waste collector according the time schedule set by the supervisory control center; fluidizing the medical waste in the container into fluidized waste particle; under the monitoring of the supervisory control center, driving by the vacuum pump, automatically transporting the fluidized medical waste particle into the carbonization tank through the connected pipeline; carbonizing the medical waste by the carbonization tank; getting the medical waste automatic collection and carbonization without of human.

What is claimed is:

1. A method for automatic classification separately collection and automatic transportation of the solid waste, contemplates a feasible process and apparatus to automatic classify the waste clearly, overcome the faults, mistake and identify ability of human and citizen, replacing the door to door collection of the waste by computer, quiet and efficiently fluidizing the waste into conductible and flowable particle, achieve solid waste automatic classification, automatic collection and get the plastic package free uniform waste for recycle and reuse, comprises the following steps and apparatus of:
Inputting the distinct data of each waste such as waste A, waste B and waste C, into the main board (21), the data including the distinct of the form, moving, color, mark and character, odor, sounder, sonic inspection, optical inspection, electric and magnetic, structure, thermoelectric, elasticity and density of each waste;
Setting the automatic waste collectors in the source of waste production, such as kitchen, and connecting the automatic waste collectors and recycle centers with pipeline;
Putting the waste into the waste receptor (8) by the monitoring of optical detector (7) and camera (11);
Dropping waste into the waste selector and producing sounder by the collision;
Detecting the waste's distinct of the form, moving, color, mark and character, odor, sounder, sonic inspection, optical inspection, electrics and magnetics, thermoelectric, elastic, structure and density by the combined detector and sensor assembly (9), optical detector (7) and camera (I 1);
Comparing the instinct of each waste inputted in the main board;
Identifying the waste by the main board (21) according the distinct detected by combined detector and sensor assembly (9), optical detector (7) and camera (11);
Putting the identified waste A into container (1), waste B into container (2), and waste C into container (3) by the waste selector (6) instructed by the main board (21);
Depositing the wastes in the containers separately;
Turning on the power of the automatic waste collector by the instruction of the supervisory control center (34) through remote information exchange system and pressure sensor (22);
Driving by the motor (32);
Fluidizing the waste B into flowable particle by the rolling fluidizing assembly (15) and exporting into the pipeline by the outlet valve and pumper assembly (23);
Turning the automatic dispatch valve (20) toward to waste B recycle center (18) by the instruction of supervisory control center (34);
Transporting the fluidized waste B into waste B recycle center (18) by the regional pumper;
Cleaning the container and pipeline by the spray (12) automatically;
Moving container (1) toward to the center position and pushing waste A into the rolling fluidizing assembly (15) by the driving and rail assembly (5);
Fluidizing the waste A into flowable particle by the rolling fluidizing assembly (15);
Turning the automatic dispatch valve (20) toward to waste A recycle center (17) by the order of the supervisory control center (34);
Transporting the fluidized waste A into waste A recycle center (17) by the pumper;
Returning the container (I) back to the original position;
Dropping waste C into rolling fluidizing assembly (15) by moving container (3) toward to center by the driving and rail assembly (5);
Fluidizing the waste C into liquid by the rolling fluidizing assembly (15);
Turning the automatic dispatch valve (20) toward to waste C recycle center (19) by the order of the supervisory control center (34);
Getting the simplified waste A, waste B, waste C without plastic package for recycle;
Preventing the hazard being put in by the alarm assembly set in the automatic waste collector, when the battery, chemical spray and paint being put in the selector, the alarm and voice warning assembly turning on by main board according the detected information from the odor, electric and magnetic detector assembly (9) and camera (11);
Sending the date recorded in the main board (21) to the supervisory control center (34) by the remote information exchange system;
That reaches at the aim of automatic classification, separately collection and automatic transportation of the solid waste and getting the simplified waste without of the plastic package for valuable recycle, and getting at the aim of replacing the manual door to door collection of the waste by computer in the office.

2. The method of claim 1 wherein identifying the distinct of physical and chemical, appearance, form, color, marks and characters, including bar code, and dimensional code, of each waste comprise of:
Reading identification, defining the color, mark, character, code, bar code and dimensional code of each waste, and getting the data from commodity, inputting the data of the color, mark, character, code, bar code and two dimensional code of each waste into the main board, putting the waste into the receptor (8), scanning and reading the color, mark, character, code, bar code and two dimensional code on the waste by the optical detector (7) and camera (11), identifying the waste by the main board (21), putting the identified waste into specified container, getting the classified waste;
Sounder identification, putting each waste into the receptor (8), following down to the selector (6) and cause sounder by collision, record the sounder of each waste as data, inputting the sound data into the main board (21); putting each waste into the receptor (8), following down to the selector (6), the sound detected by the sound and sonic detector (9), identifying by the main board (21), getting the classified waste;
Optical identification, inputting the absorptance and reflectance of each waste into the main board (21), putting the waste into the receptor (8), following down to the selector (6), identifying the waste by the main board according to the absorptance and reflectance of the waste detected by the optical detector (7), putting the waste into specified container, and getting the classified waste;
Electric and magnetic identification, inputting the distinct of electric and magnetic of each waste into the main board (21), putting the waste into the receptor (8), following down to the selector (6), identifying the waste by the main board according to the distinct of electric and magnetic of the waste detected by the electric and magnetic detector (9), putting the waste into specified container, and getting the classified waste;
Odor identification, inputting the distinct of odor of each waste into the main board (21), putting the waste into the receptor (8), following down to the selector (6), identifying the waste by the main board according to the distinct of odor of the waste detected by the odor detector (9), putting the waste into specified container, and getting the classified waste;
Image and graphic identification, tow dimension and three dimensions identify. inputting the distinct of the image of each waste into the main board (21), putting the waste into the receptor (8), following down to the selector (6), identifying the waste by the main board according to the distinct of the image of the waste detected by the optical detector (7) and camera (11), putting the waste into specified container, and getting the classified waste;
Density identification and selection, inputting the distinct of the density of each waste into the main board (21), including the extended difference of the definite density set for the wastes by the manufacture, putting the waste into the receptor (8), following down to the selector (6), identifying the waste by the main board according to the distinct of the density of the waste detected by the piezoelectric detector (33) and optical detector (7), putting the waste into specified container, and getting the classified waste, and selecting the waste collected into much more detail classification by the gravity selection;
Sonic identification, inputting the distinct of the structure of each waste into the main board (21), putting the waste into the receptor (8), following down to the selector (6), identifying the waste by the main board according to the distinct of the structure of the waste detected by the sonic detector (9), putting the waste into specified container, and getting the classified waste;
Thermoelectric identification, inputting the distinct of the temperature of each waste into the main board (21), putting the waste into the receptor (8), following down to the selector (6), identifying the waste by the main board according to the distinct of the temperature of the waste detected by the thermoelectric detector and infrared sensor (9), putting the waste into specified container, and getting the classified waste;
Selective identification, inputting the distinct data of plastic only into the main board (21), putting the waste into the receptor (8), following down to the selector (6), identifying the waste by the main board according to the distinct detected, if the distinct detected by the detector assembly is plastic, putting the plastic into plastic container, if no any distinct detected, putting all of another waste into biodegradable container, and getting the classified waste;
Cross employed, Reading, Sounder, Optical, Electric and magnetic, Odor, Image, Density, Sonic, thermoelectric, Selective identification can be cross-employed for the waste identification.

3. The method of claim 1 wherein the automatic waste collector which is designed to a quiet, safe, high efficient and remote manageable for automatic classification, separately collection, fluidizing and automatic transportation of the waste, is comprised of: the user going near the automatic waste collector, the lid (10) is automatically opened by infrared sensor assembly, putting the waste into the waste receptor (8), and following down to the waste selector (6), the optical detector (7) and the camera (11) detect the form, moving, color, mark and character, ray absorptance and reflectance of waste, the piezoelectric sensor (33) gets the weight and density of the waste, the sonic, sounder, electronic and magnetic, thermoelectric and odor detector assembly (9) detects the temperature, collision sounder, structure, electric and magnetic, odor and elasticity of the waste, identifying the waste by the main board (21) according to the data detected, putting the identified waste A in the selector (6) into the waste container (1) by the selector driving assembly (13) and rail (14), the identified waste B into the container (2), the identified waste C into the container (3); depositing the wastes in the containers; container (2) is mounted on the top of rolling fluidizing assembling (15), instructing by the supervisory control center (34), turning on the regional vacuum pump and turning the dispatcher valve (20) set in front of the waste recycle centers toward to waste B recycle center (18), building up the pressure in the pipeline, the pressure sensor (22) set in the pipeline detects the difference of the pressure in the pipeline, and turns on the power of the automatic waste collector, driving by the motor (32), the different gear couple assembly (16) make the saw and cut roller (29) and the saw and cut roller (30) counter-rolling with different speed that forms the vertical saw and cut, and transverse cut and shred, which cut and saw the waste into particles without of noise, preventing the waste conglutination on the saw and cut rollers and directing the waste into the conducting tunnel by the comb (31), the sharp edge of the rolling screw push rod (28) and the fixed transverse cut (27) forms cutting, the circumferential face of the rolling screw push rod (28) and the grooves (26) inside the tunnel goes further cut and grind the waste and push the waste going toward to the granularity controlling screen net (24) and cut (25), by setting the diameter of the hole on the granularity controlling screen net (24), cutting by the cut (25) and the granularity controlling net (24), getting the designed granularity of the fluidized waste particles, driving by the exporting pumper (23) and the fluidized waste going through the automatic outlet valve (23) into the pipeline, and conducting waste B through the pipeline into the waste B recycle center (18) by the automatic dispatch valve (20); automatically cleaning the container and pipeline by the spray (12); modifying the working condition by a heater set in the conducting tunnel; the bottoms of container (1) and container (3) are sliding when container (1) and container (3) are moved toward the center by the container driving assembly (5) and pushing the identified wastes in the containers into the rolling fluidizing assembly (15); moving container (1) toward to center by the set program in the main board, pushing the waste A into the rolling fluidizing assembly (15), fluidizing waste A into fluidized waste particle, turning the automatic dispatch valve (20) toward to waste A recycle center (17), driving the fluidized waste A to waste A recycle center (17) by the pumper; then moving the container (3) toward to center, push the waste C into the rolling fluidizing assembly (15), fluidizing waste C into fluidized waste particle, turning the automatic dispatch valve (20) toward to waste C recycle center (19), driving the fluidized waste C to waste C recycle center (19) by the pumper; that getting the classified uniform waste A, waste B and Waste C without plastic package for valuable recycle; the controlling panel (4) set for managing the automatic waste collector; as a remote terminal unit, the automatic waste collector automatically sends the statistic date recorded in the main board (21), including the monthly producing amount of each waste, producing time period and troubleshooting report to the supervisory control center (34) by the instruction of the supervisory control center (34) through the remote information exchange system; The number of the containers set in the automatic waste collector can be extended; the hazard is prevented by the alarm assembly.

4. The method of claim 1 wherein the supervisory control center (34) which is employed to automatically manage and monitor the automatic waste transporting pipeline, the automatic dispatch valves and the automatic waste collectors set in a regional area, the whole city and town, is comprised of: the center computer and controlling system, inputting the program and instruction into the computer by the human machine interface; the manager controls the system which is made of the pipeline, remote terminal unit, the automatic waste collectors, the regional pumpers and the regional dispatch valves; the data acquisition system which is set for the data collection, record and display; organizing, editing and compiling the instruction and the data collected by the programmable logic controller; the information exchanges in the system by the remote information exchange system; reaching at the automatic billing, automatic statistic of the data, category, decision making, diagnosis, determining defect, troubleshooting, displaying the information in a logical and organized fashion, monitoring the wastes separately collection and transportation, pipeline working condition, making waste collection and dispatch schedule and plan.

5. The automatic waste collector of claim 2 wherein the rolling fluidizing assembly which is designed to reach at a quiet and high efficient, composed of: driving by the different gear couple (204) and (205) with low counter-rolling speed, the sawtooth and cut on the saw and cut roller (201) and (202) forms a strong static cutting in the waste into particle without noise; the small gear (204) and large gear (205) make the saw and cut roller (201) and the saw and cut roller (202) counter-rolling with different speed that forms the vertical saw and cut, and transverse cut and shred, which cut and saw the waste into particles; preventing the waste conglutination on the saw and cut rollers and directing the waste into the conducting tunnel by the comb (203), the sharp edge of the rolling screw push rod (211) and the fixed transverse cut (213) forms the second transverse cutting, the circumferential face (212) of the rolling screw push rod and the grooves (214) inside the conducting tunnel goes further cut and grind the waste and the face (215) of the rolling screw push rod pushes the waste going toward to the granularity controlling net (206) and cut (207), by setting the diameter of the hole on the granularity controlling net (206), cutting by the cut (207) and the granularity controlling net (206), getting the designed granularity of the fluidized waste particles; the heater (210) set in the conducting tunnel is the first to modifying the working condition to accommodate the bad working condition, such as winter; the second is to soft the waste, such as to make plastic soft, shrink and directly cut into grain, to get renewed products, increase the efficient and optimize the waste recycle process; the third is to melt some waste, such as oil, and prevent it's conglutination on the parts. The rolling waste fluidizing assembly can be simplified for specified use.
